(19) United States
(12) Patent Application Publication
(10) Pub. No.: US 2011/0165975 A1
(43) Pub. Date: Jul. 7, 2011

(54) System and Method for a Pre-Formed Reinforcement Member for an Opening in a Game Racket

(76) Inventor: Brett Bothwell, New York, NY (US)

(21) Appl. No.: 13/046,723

(22) Filed: Mar. 12, 2011

Related U.S. Application Data
(63) Continuation-in-part of application No. 12/072,030, filed on Feb. 21, 2008, now Pat. No. 7,938,747.
Application No. 12/072,030 is a continuation-in-part of application No. 11/986,828, filed on Nov. 26, 2007, now Pat. No. 7,927,239.

(51) Int. Cl. A63B 49/10; A63B 49/02; B32B 37/02; B32B 38/00; B29C 65/72; B29C 65/70

(52) U.S. Cl. 473/535; 473/540; 156/185

(57) ABSTRACT

A system and method for creating a game racket with pre-formed reinforcement members in various openings in the game racket. A composite game racket frame comprising at least one elongated string channel opening in the frame head, bridge or other area, at least one reinforcement member adapted to fit within the elongated opening and configured to allow one or more game racket string to pass through the reinforcement member, and at least one string bearing member adapted to fit on the outside of the game racket frame to support the game racket string. A method for producing a game racket frame comprising the acts of preparing a single or double bladder with at least one elongated opening for molding in a mold cavity, wrapping the exposed bladder surfaces with a pre-preg material, placing the wrapped bladder in a mold cavity in the shape similar to a game racket frame, placing at least one spacer within an elongated opening, closing the mold cavity and heating it to fully prepare the pre-preg material, and then opening the mold cavity and removing the composite game racket frame.

### CROSS REFERENCE TO RELATED APPLICATION

This application is a continuation-in-part of U.S. application Ser. Nos. 12/072,030 entitled ‘Game Racket Including a Pivot Element’ to Brett Bothwell filed on Feb. 28, 2008 and 11/986,828 entitled ‘Substantially Fluid Tight Game Racket Including a Spring Suspension Module’ to Brett Bothwell filed on Nov. 26, 2007, the disclosures of which are herein incorporated by reference in their entirety.

### BACKGROUND OF THE INVENTION

1. Field of the Invention

Aspects of the present disclosure relate to the field of game racket frames. In particular, this disclosure relates to game racket frames with strings held in tension and used for striking any object such as but not limited, to a tennis ball, squash ball, racket-ball, or badminton bird. More specifically, the present invention relates to elongated string channel openings in a composite game racket head frame or bridge portion.

2. Description of Related Art

Game rackets typically include a head portion containing interwoven strings held in tension, a handle, and a shaft or throat connecting the head portion to the handle. Conventional composite rackets have holes spaced around the periphery of the head frame and bridge portions through which the strings are laced. Unfortunately, when string holes are drilled through the composite material it weakens the frame significantly.

One example of a manner in which the drilling of string holes in a frame has been eliminated is by an inflation bladder molding technique in which two bladders are used instead of one, as is typical. U.S. Pat. No. 6,800,239 to Davis (hereinafter “Davis”) describes a way to achieve pre-formed string holes using this “double bladder.” A double bladder racket is stronger than a frame with conventional drilled string holes and has an increased effective string surface area. Although intended to reduce labor costs, the method described by Davis has proven to be labor intensive and therefore costly.

In an adaptation of the aforementioned molding technique, U.S. Pat. No. 7,396,303 to Gazzara, et al. (hereinafter “Gazzara”) suggests making “cutouts” or elongated openings in the head frame of a game racket. A separate bearing “insert” is provided to act as a grommet and anchor the strings. The insert simplifies fabrication of the frame by enabling larger elongated openings instead of individual string holes and/or ports. A critical drawback of the design is that the frame profile is seriously destabilized by the elongated openings.

Traditionally, each of two bladders is wrapped individually with pre-preg material before being inserted into the mold cavity. To make an opening in the frame, the bladders are separated at strategic locations in the mold cavity to create voids. This method has a number of serious drawbacks. For example, the internal wall that's formed in the frame profile between the bladders is continuous and therefore exists even in locations where it's unnecessary. Not only can this make the racket heavier and stiffer than desired, but it's also wasteful of composite material and therefore, costly. It's also been demonstrated that the labor saving design employing elongated openings is structurally deficient and requires reinforcement and ideally an improved molding method.

So as to reduce the complexity and length of the Detailed Specification, and to fully establish the state of the art in certain areas of technology, Applicant(s) herein expressly incorporate(s) by reference all of the following materials identified in each numbered paragraph below.

U.S. Pat. No. 6,800,239

U.S. Pat. No. 7,396,303

U.S. Pat. No. 5,458,331

U.S. Pat. No. 6,503,161

U.S. Pat. No. 6,971,964

Applicant(s) believe(s) that the material incorporated above is “non-essential” in accordance with 37 CFR 1.57, because it is referred to for purposes of indicating the background of the invention or illustrating the state of the art. However, if the Examiner believes that any of the above-incorporated material constitutes “essential material” within the meaning of 37 CFR 1.57(c)(1)-(3), applicant(s) will amend the specification to expressly recite the essential material that is incorporated by reference as allowed by the applicable rules.

### BRIEF SUMMARY OF THE INVENTION

The present invention provides among other things a game racket with improved performance. A distinguishing feature of the game racket provided is an elongated string channel opening on a head frame or bridge portion. The elongated opening achieves a greater effective string length and therefore a larger optimum string hitting area. The invention provides a pre-formed structural reinforcement member for such an elongated opening in order to maximize the strength and performance potential of the racket. The pre-formed reinforcement member can be inserted into a frame mold prior to the forming of the racket, or it can be inserted into an opening in the racket after it's formed. An elongated opening on the game racket of the invention, through which the strings pass without touching, allows flexibility with the type of structure employed to anchor the strings in position. The game racket of the invention can be made using one of two improved inflation bladder molding methods.

An objective of the present invention is to provide a game racket frame with reinforced elongated string channel openings molded by an improved “double bladder” inflation molding method. Another objective is to provide a game racket frame with reinforced elongated string channel openings molded by an improved “single bladder” molding method. A further objective of the present invention is to simplify the molding process associated with making openings in the head frame or bridge portion and subsequently to reduce the labor required and the cost. It is another objective to enable flexibility with the type of string bearing structure utilized.

A reinforced elongated opening of the improved “double bladder” molding method is achieved using a mold spacer that is actually the pre-formed reinforcement member itself. The spacer/reinforcement member is left in place after the frame is cured and becomes integral with the racket. A reinforced elongated opening of the improved “single bladder” molding method is achieved using a bladder which is pre-made with corresponding openings. In this case, the mold spacer could be typical and removed from the racket after it's molded, or it could be a pre-formed reinforcement member and left in place to become integral with the racket.

The pre-formed reinforcement member itself is made separately from the frame and therefore can be made of one of any number of materials utilizing one of any number of fabrication methods including but not limited to reinforced composite plastic by the inflation bladder molding method or by a common lay-up/lamination method. The member can also be injection molded thermo-plastic suitably lightweight and strong for its purpose or it could also be formed of a metal alloy.

The above and other objects may be achieved using devices involving a composite game racket frame comprising at least one elongated string channel opening located on frame of the racket. The racket frame further comprises at least one reinforcement member which is formed to fit within the elongated opening and has at least one opening which is configured to allow at least one racket string to pass through the reinforcement member. The racket further comprises at least one string bearing member, which is adapted to fit on the outward facing surface of the racket frame and on top of the at least one reinforcement member, and which supports the at least one racket string and contacts the at least one racket string.

The above and other objects may be achieved using devices wherein the reinforcement member comprises a spacer with removable end panels and which is placed in the game racket frame before molding.

The above and other objects may be achieved using devices wherein the reinforcement member comprises an integral pre-formed member which is placed in the game racket before molding.

The above and other objects may be achieved using devices wherein the reinforcement member comprises a material and thickness which is sufficient to resist a non-elastic deformation.

The above and other objects may be achieved using devices wherein there is at least one secondary support member within the reinforcement member.

The above and other objects may be achieved using devices wherein an at least one secondary member is perpendicular to an axis formed by a string hitting surface on the game racket frame.

The above and other objects may be achieved using devices wherein an at least one secondary member is diagonal to an axis formed by a string hitting surface on the game racket frame.

The above and other objects may be achieved using devices wherein the reinforcement member comprises a metal, a plastic composite material, and/or an injection molded member.

The above and other objects may be achieved using devices wherein the string bearing portion is partially inserted into the game racket frame.

The above and other objects may be achieved using devices wherein the at least one elongated string channel opening on the game racket frame is located on a head frame member of the game racket frame.

The above and other objects may be achieved using devices wherein the at least one elongated string channel opening on the game racket frame is located on a bridge member of the game racket frame.

The above and other objects may be achieved using a composite game racket frame comprising a single bladder wrapped in pre-preg material and cured in a mold cavity to create a game racket frame wherein the single bladder has at least one elongated string channel opening. The racket frame further comprises at least one reinforcement member which is formed to fit within the elongated opening and has at least one opening which is configured to allow at least one racket string to pass through the reinforcement member. The racket further comprises at least one string bearing member, which is adapted to fit on the outward facing surface of the racket frame and on top of the at least one reinforcement member, and which supports the at least one racket string and contacts the at least one racket string.

The above and other objects may be achieved using methods involving methods involving preparing at least one bladder with at least one elongated opening for molding in a mold cavity, wrapping the exposed bladder surface areas with a pre-preg material to create a wrapped bladder, placing the wrapped bladder in the mold cavity in a shape approximating the shape of the game racket frame, and placing at least one spacer within the at least one elongated opening. Such methods further involve closing the mold cavity, pressurizing the at least one bladder, heating the mold cavity to fully cure the pre-preg material, opening the mold cavity, and removing the composite game racket frame from the mold cavity.

The above and other objects may be achieved using methods wherein the spacers comprise a hollow element with knockout end panels and wherein the methods further comprise the act of removing the knockout end panels after removing the composite game racket frame from the mold cavity.

The above and other objects may be achieved using methods further comprising the acts of removing the spacer from the game racket frame after removing the game racket frame from the mold cavity in order to create an elongated opening and inserting a reinforcement member in the elongated opening.

The above and other objects may be achieved using methods wherein the spacer is a reinforcement member.

The above and other objects may be achieved using methods further comprising the act of locking in place intermediate mold members.

The above and other objects may be achieved using methods further comprising the act of placing string bearing members on an outward facing portion of the reinforcement member.

Aspects and applications of the invention presented here are described below in the drawings and detailed description of the invention. Unless specifically noted, it is intended that the words and phrases in the specification and the claims be given their plain, ordinary, and accustomed meaning to those of ordinary skill in the applicable arts. The inventor is fully aware that he can be his own lexicographer if desired. The inventor expressly elects, as his own lexicographer, to use only the plain and ordinary meaning of terms in the specification and claims unless they clearly state otherwise and then further, expressly set forth the “special” definition of that term and explain how it differs from the plain and ordinary meaning. Absent such clear statements of intent to apply a “special” definition, it is the inventor's intent and desire that the simple, plain and ordinary meaning to the terms be applied to the interpretation of the specification and claims.

The inventor is also aware of the normal precepts of English grammar. Thus, if a noun, term, or phrase is intended to be further characterized, specified, or narrowed in some way, then such noun, term, or phrase will expressly include additional adjectives, descriptive terms, or other modifiers in accordance with the normal precepts of English grammar. Absent the use of such adjectives, descriptive terms, or modifiers, it is the intent that such nouns, terms, or phrases be given their plain, and ordinary English meaning to those skilled in the applicable arts as set forth above.

Further, the inventor is fully informed of the standards and application of the special provisions of 35 U.S.C. §112, ¶6. Thus, the use of the words “function,” “means” or “step” in the Detailed Description or Description of the Drawings or claims is not intended to somehow indicate a desire to invoke the special provisions of 35 U.S.C. §112, ¶6, to define the invention. To the contrary, if the provisions of 35 U.S.C. §112, ¶6 are sought to be invoked to define the inventions, the claims will specifically and expressly state the exact phrases “means for” or “step for, and will also recite the word “function” (i.e., will state “means for performing the function of [insert function]”), without also reciting in such phrases any structure, material or act in support of the function. Thus, even when the claims recite a “means for performing the function of . . . ” or “step for performing the function of . . . ,” if the claims also recite any structure, material or acts in support of that means or step, or that perform the recited function, then it is the clear intention of the inventors not to invoke the provisions of 35 U.S.C. §112, ¶6. Moreover, even if the provisions of 35 U.S.C. §112, ¶6 are invoked to define the claimed inventions, it is intended that the inventions not be limited only to the specific structure, material or acts that are described in the preferred embodiments, but in addition, include any and all structures, materials or acts that perform the claimed function as described in alternative embodiments or forms of the invention, or that are well known present or later-developed, equivalent structures, material or acts for performing the claimed function.

### BRIEF DESCRIPTION OF THE SEVERAL VIEWS OF THE DRAWINGS

A more complete understanding of the present invention may be derived by referring to the detailed description when considered in connection with the following illustrative figures. In the figures, like reference numbers refer to like elements or acts throughout the figures.

FIG. 1 shows a 3-dimensional view of a game racket including the reinforced elongated string openings of the present invention.

FIGS. 2A-C shows a cross-sectional view along line 1-1 in FIG. 1 of a head frame profile.

FIG. 3 shows a 3-dimensional detail view of a sequence of reinforced elongated string openings including a secondary support member on the head frame of the invention.

FIG. 4 shows a 3-dimensional detail view of a sequence of reinforced elongated string openings including a secondary support member on a bridge portion of the invention.

FIG. 5 shows a schematic 3-dimensional detail view of a bladder including openings and corresponding spacers.

FIG. 6 shows a 3-dimensional view of a mold plate including a mold cavity, a bladder with elongated openings, and corresponding spacers.

FIG. 7 shows a 3-dimensional view of a mold plate including a mold cavity, two bladders, and corresponding spacers.

FIG. 8 depicts an example method of making a composite game racket.

Elements and acts in the figures are illustrated for simplicity and have not necessarily been rendered according to any particular sequence or embodiment.

### DETAILED DESCRIPTION OF THE INVENTION

In the following description, and for the purposes of explanation, numerous specific details are set forth in order to provide a thorough understanding of the various aspects of the invention. It will be understood, however, by those skilled in the relevant arts, that the present invention may be practiced without these specific details. In other instances, known structures and devices are shown or discussed more generally in order to avoid obscuring the invention. In many cases, a description of the operation is sufficient to enable one to implement the various forms of the invention, particularly when the operation is to be implemented in software. It should be noted that there are many different and alternative configurations, devices and technologies to which the disclosed inventions may be applied. The full scope of the inventions is not limited to the examples that are described below.

The present invention is a game racket with improved performance. The racket includes a handle, a bridge portion, and a head frame laced through with strings held in tension to form a stringed hitting surface. In particular, at least one head frame portion or bridge portion includes a reinforced string channel opening. The present invention provides a reinforcement member for such an opening as well as two improved inflation bladder molding techniques, each of which can be employed to form the racket.

The reinforcement member of the invention can be made of any strong, lightweight material such as reinforced plastic, injection molded thermo-plastic, and potentially metal alloy. The member is pre-formed and can be either integrated into the racket frame during the molding process, or inserted and secured into the racket frame after the racket is molded.

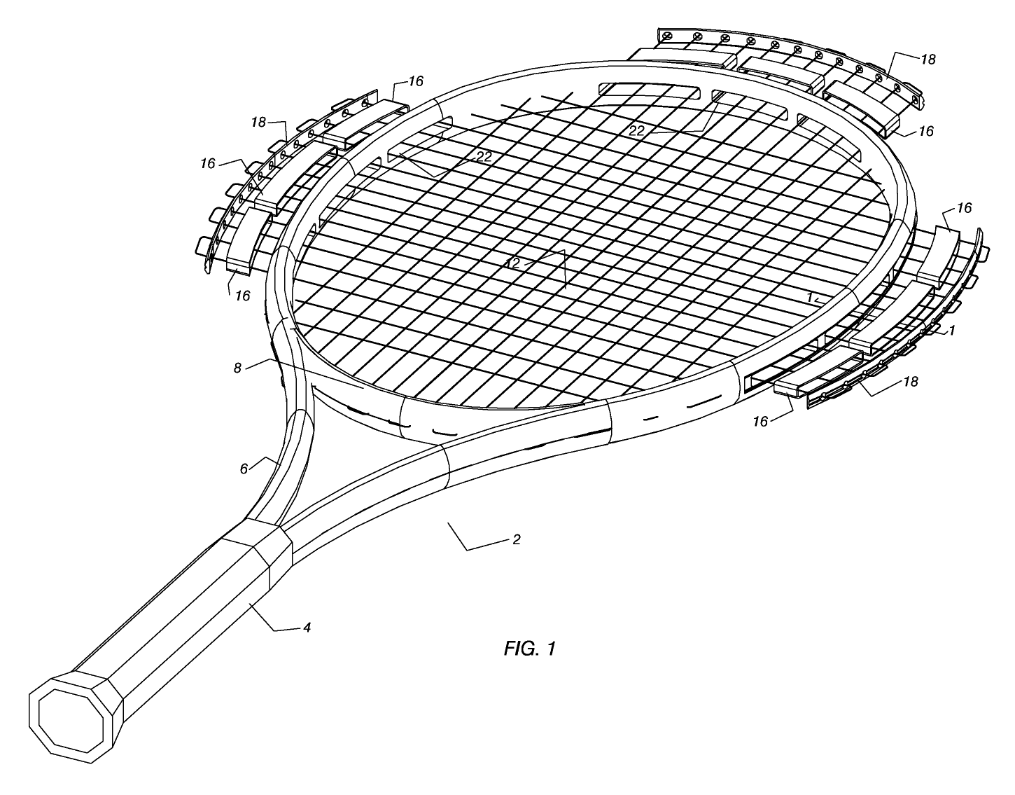

A game racket 2 of the present invention is shown in perspective view of FIG. 1. In various implementations, the racket 2 may comprise a handle 4, a throat 6, a head frame 10, and a bridge member 8. In various implementations, the head frame 10 may form a closed approximately oval shape, thus eliminating the need for the bridge member 8. Strings may be laced through the head frame 10 and bridge member 8 to form a stringed hitting surface 12. In various implementations, at least one elongated string channel opening 22 is included on the head frame 10. While any number of elongated string channel openings may be on the head frame 10 or bridge member 8, the implementation depicted comprises nine elongated string channel openings 22. In a conventional racket, the strings are laced through holes in a head frame to form a stringed surface 12. In various implementations of the present invention, however, a number of strings are laced through an elongated string channel opening 22 instead. The openings 22 can be located anywhere on the head frame 10 or bridge member 8. In some implementations, a “tie-off” or knot of the stringed surface 12 is required and may prevent the placement of an elongated string channel opening. In order to strengthen the head frame 10 in the area of the openings 22, a reinforcement member 16 for at least one of the elongated string channel openings is provided. For the purpose of illustration and not limitation, the reinforcement members 16 are shown in this perspective view prior to being secured within the openings 22. In order to anchor those strings which pass through an elongated opening 22, a string bearing bar 18 may be included. In other implementations, any element that allows the string to pass through the reinforcement member and wrap through and/or around the string bearing bar 18 may be utilized. In some implementations, a single string bearing bar 18 may mate with a single elongated opening 22 and/or reinforcement member 16, while in other implementations a single string bearing bar 18 may mate with or cover two or more elongated openings 22 and/or reinforcement members 16. The string bearing bar 18 can be mounted on the racket 2 after the frame is molded.

An advantage of the invention is that the reinforcement member 16 and the string bearing bar 18 are separate parts and this allows flexibility in how each can be made. The material used for each part can be different and therefore more specifically suited to its application. While one of ordinary skill in the art would recognize that any appropriate materials may be used, the following provides several non-limiting examples of materials used in implementations of the invention. For example, it may be that the string bearing bar 18 should be made of thermo-plastic due to its vibration dampening properties, and the reinforcement member 16 should instead be made of reinforced plastic, for structural purposes. In other implementations, the string bearing bar 18 and the reinforcement member 16 may comprise any type of plastic, metal, or other material. For certain rackets, a thermo-plastic string bearing bar 18 will be too heavy; in which case a reinforced plastic bar may be better.

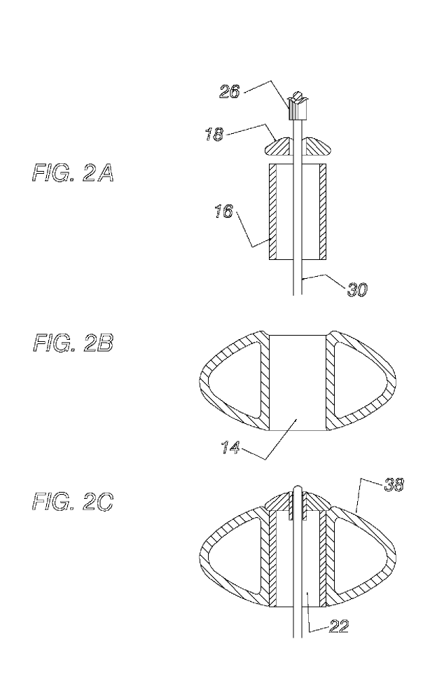

A cross-sectional view along line 1-1 of the racket of FIG. 1 is shown in FIGS. 2A-C. This view illustrates the parts that may be separate from one another in various implementations. In FIG. 2A, a string 30 is shown going through a string bearing bar 18. The grommet 26 is not yet in contact with the string bearing bar 18 in FIG. 2A, while FIG. 2C depicts the grommet 26 within a hole in the string bearing bar 18. FIG. 2A also depicts the string going through the reinforcement member 16. FIG. 2B depicts a cross section of a head frame 10 and the opening left by the space in the frame 14. In FIG. 2C, the reinforcement member 16 is secured into an elongated opening 22 in a frame profile 38. The frame profile depicted may comprise any part of the racket 2, including but not limited to the head frame 10 or the bridge member 8.

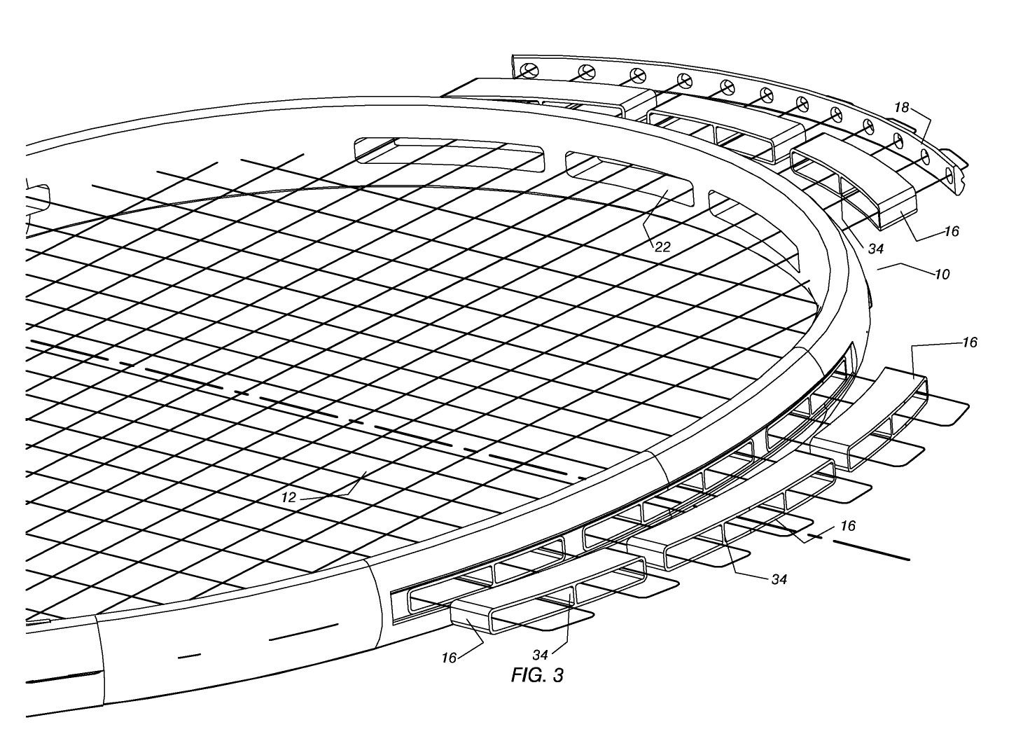

FIG. 3 depicts a perspective view of the game racket 2 with an embodiment of the reinforcement member 16 separated from the head frame 10 of a game racket 2, though this could be a bridge member 8 or any part of the racket 2 as well. For illustrative purposes, the string bearing bar is not depicted in this view. The particular reinforcement members 16 shown here have one or two secondary support member 34. In other implementations, the reinforcement members 16 may comprise any number of secondary support members 34. In other implementations, the secondary support members 34 may run any direction within the reinforcement member. The support member(s) 34 act like pillars under a bridge span to resist bending forces due to use, acting on the span of the reinforcement member 16.

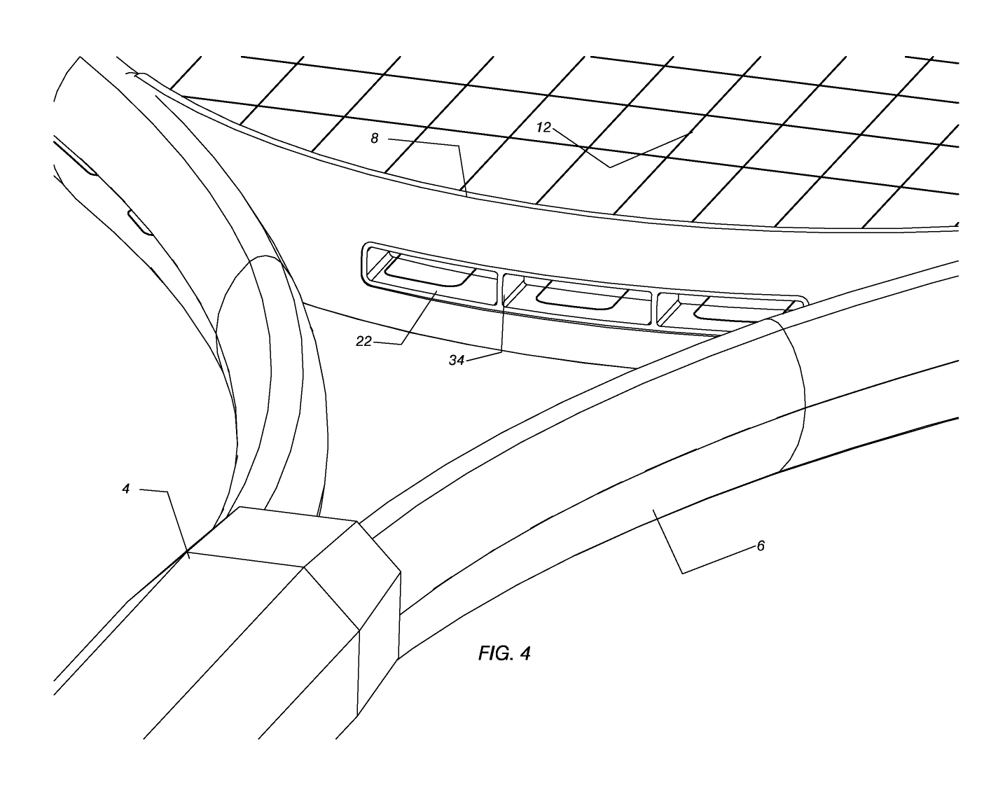

FIG. 4 depicts a game racket 2 of the present invention with a reinforcement member 16 secured in place within an elongated opening 22 on a bridge member 8 of the racket 2. For illustrative purposes, the string bearing bar is not depicted in this view. Other locations for reinforced elongated openings 22 on a head frame 10 are possible and may be desirable for various reasons and will likely become apparent to those skilled in the art.

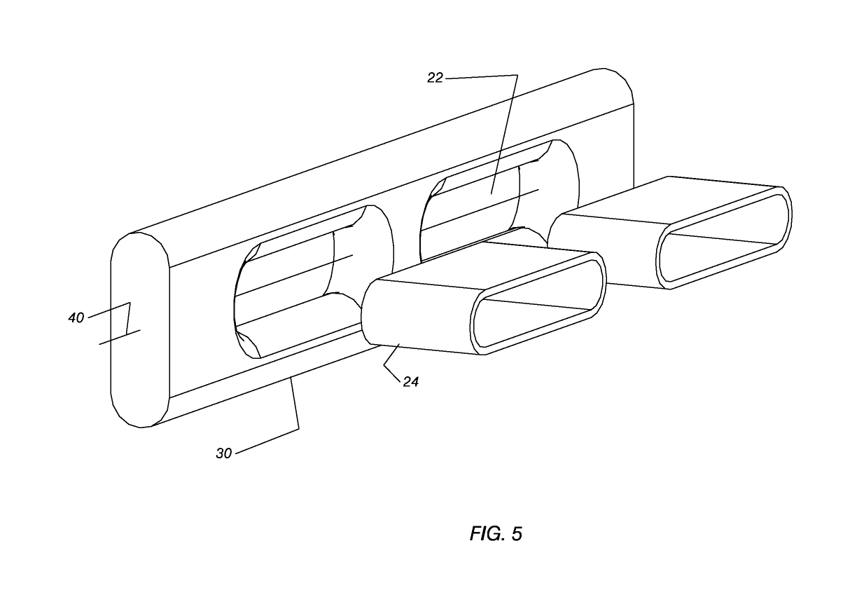

FIG. 5 shows a perspective representation of an inflation molding bladder 30 having two elongated through openings 22 aligned with its central longitudinal axis 40, and a corresponding mold spacer 24 for each. In one implementation, the spacer 24 may be a removable, re-usable mold part which is simply removed after the racket is molded to leave an opening. In another implementation, the spacer 24 may be a part that is molded integrally with a racket and remains in place when the racket is removed from the mold.

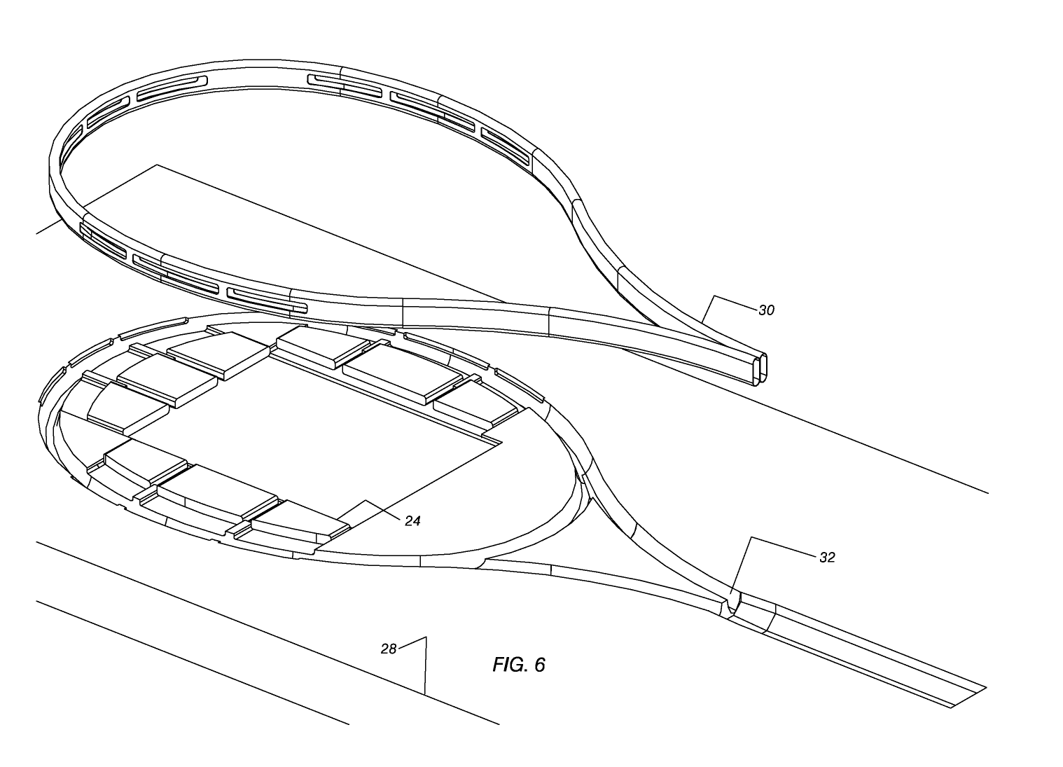

FIG. 6 shows a 3-dimensional view of a mold plate 28 including a racket frame cavity 32. In this implementation a single inflation molding bladder 30 is shown prior to placement in the mold cavity 32. The bladder 30 has multiple elongated openings, each of which corresponds to the location of a spacer 24 within the cavity 32. After the bladder is placed in the cavity 32, a spacer 24 can be slid into position in the mold cavity, through a bladder opening, and secured.

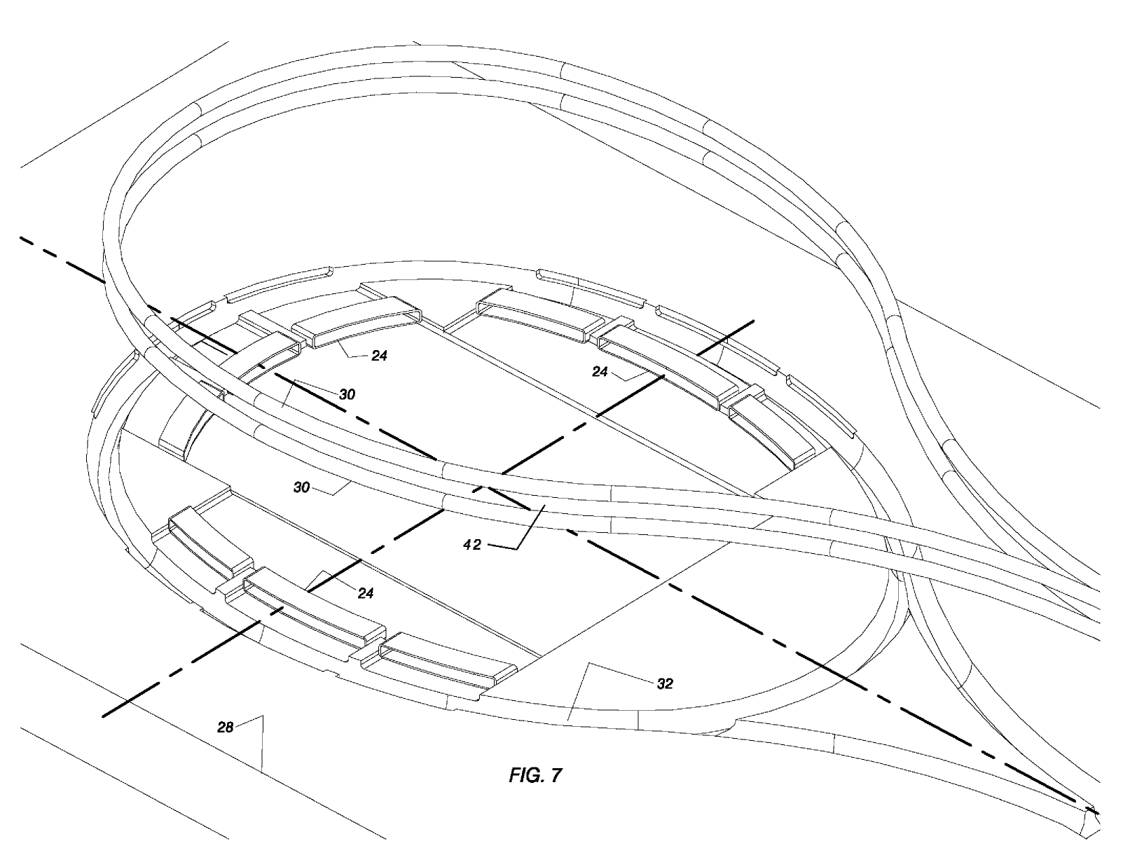

FIG. 7 shows a 3-dimensional view of a mold plate 28 including a racket frame cavity 32. In this particular implementation, two bladders 30 with an elongated opening 42 are shown prior to placement in the mold cavity 32. After a first bladder is placed into the mold cavity, a spacer 24, which may be hollow or solid and may also be similar to reinforcement member 16, can be slid into position in the mold cavity 32 and secured. After a spacer and/or reinforcement member 24 is secured in place, a second bladder 30 is placed in the cavity 32. After the second bladder is placed into the mold cavity 32, a second mold plate 28 including a mold cavity 32 is placed on top and secured in place.

One important advantage of the reinforcement member of the invention is that the resulting racket has improved performance and strength and yet it's made using conventional inflation molding techniques. One important innovation which allows improvement to the single bladder molding technique is the capacity to make an inflation bladder with openings along its central longitudinal axis. This allows internal inflation molding pressure to expand within the spaces between elongated openings thus forming integral structural members.

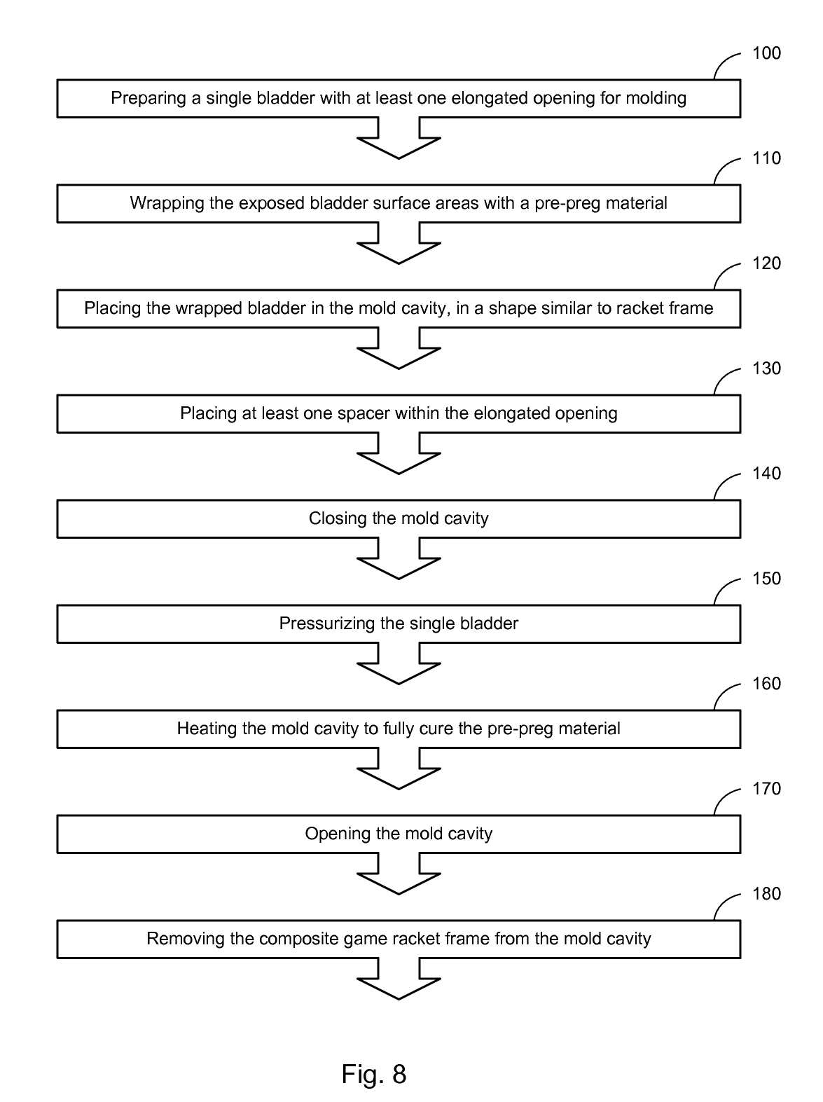

FIG. 8 depicts a flowchart of a method for making a composite game racket frame. In one implementation, the method may comprise preparing at least one bladder with at least one elongated opening for molding in a mold cavity 100. In another implementation the method may comprise using two bladders, as seen in FIG. 7. The elongated opening may be placed in the bladder by a variety of methods. In various implementations, the method may comprise any number of elongated openings. The method may further comprise wrapping at least a portion of a bladder surface with a pre-preg material to create a wrapped bladder 110. In some implementations, the wrapping the bladder comprises wrapping exposed bladder surface area with the pre-preg material 110. The method may further comprise placing at least one wrapped bladder in the mold cavity in a shape substantially similar to the game racket frame 120. In other implementations the mold cavity may be shaped in any variety of shapes or configurations. Placing a wrapped bladder in the mold cavity may be done in a variety of manners, including but not limited to by hand, manually, by machine, and the like.

The method may further comprise placing at least one spacer within the at least one elongated opening in the single bladder 130. In some implementations, there is one corresponding spacer for each elongated opening. In other implementation, a plurality of spacers may be used in a single elongated opening. Placing at least one spacer within an elongated opening may be accomplished by a variety of actions, including but not limited to by hand, manually, by machine, and the like. In some implementations, the spacer may comprise a hollow element.

The method may further comprise closing the mold cavity member 140. Closing the mold cavity member may be done manually, by hand, by machine, automatically, and the like. The method may further comprise pressuring the bladder 150. Pressurizing the bladder may be done by a variety of actions. The method may further comprise heating the molding cavity; in one implementation, heating the mold cavity member fully cures the pre-preg material 160. The method may further comprise opening the mold cavity member by any suitable method 170. The method may comprise removing the composite game racket frame from the mold cavity 180.

In various implementations, the method may further comprise the act of removing the spacer from the game racket frame. Removing the spacer may be done by any variety of actions, such as manually, by hand, automatically, by machine, and the like. Various implementations may further comprise the act of inserting a reinforcement member in the elongated opening at any point during the method. In some implementations, the spacer itself may comprise the reinforcement member.

In still additional implementations, the method may comprise locking intermediate mold members in place in the mold cavity. String bearing members may also be placed on an outward facing portion of the reinforcement member at any point during the method.

In places where the description above refers to particular implementations of game rackets and techniques for manufacturing game rackets, it should be readily apparent that a number of modifications may be made without departing from the spirit thereof and that these implementations may be applied to other to game rackets and techniques for manufacturing game rackets.

I claim:

1. A composite game racket frame, comprising:
at least one elongated string channel opening on the game racket frame;
at least one reinforcement member adapted to fit within the elongated opening, the reinforcement member comprising at least one opening and configured to allow at least one game racket string to pass through the reinforcement member; and
at least one string bearing member adapted to fit on a portion of an outward facing surface of the game racket frame and on top of an outside portion of the at least one reinforcement member and support the at least one game racket string, wherein the at least one string bearing member contacts the at least one game racket string.

2. The composite game racket frame of claim 1, wherein the reinforcement member comprises a hollow spacer placed in the game racket frame before molding.

3. The composite game racket frame of claim 1, wherein the reinforcement member comprises an integral preformed member placed in the game racket frame before molding.

4. The composite game racket frame of claim 1, wherein the reinforcement member comprises a separate preformed member placed in the game frame racket after molding.

5. The composite game racket frame of claim 1, wherein the reinforcement member comprises a material and thickness sufficient to resist a non-elastic deformation.

6. The composite game racket frame of claim 1, further comprising at least one secondary support member within the reinforcement member.

7. The composite game racket frame of claim 6, wherein the at least one secondary support member is perpendicular to an axis formed by a stringed hitting surface on the game racket frame.

8. The composite game racket frame of claim 6, wherein the at least one secondary support member is diagonal to an axis formed by a stringed hitting surface on the game racket frame.

9. The composite game racket frame of claim 1, wherein the reinforcement member comprises a metal.

10. The composite game racket frame of claim 1, wherein the reinforcement member comprises a plastic composite material.

11. The composite game racket frame of claim 1, wherein the reinforcement member comprises an injection molded member.

12. The composite game racket frame of claim 1, wherein the string bearing portion is at least partially inserted in the game racket frame.

13. The composite game racket frame of claim 1, wherein the at least one elongated string channel opening on the game racket frame comprises at least one elongated string channel opening on a head frame member of the game racket frame.

14. The composite game racket frame of claim 1, wherein the at least one elongated string channel opening on the game racket frame comprises at least one elongated string channel opening on a bridge member of the game racket frame.

15. A composite game racket frame, comprising:
a single bladder wrapped in pre-preg material and cured in a mold cavity to create a game racket frame, the single bladder comprising at least one elongated string channel opening;
at least one reinforcement member adapted to fit within the elongated opening, the reinforcement member comprising at least one opening and configured to allow at least one game racket string to pass through the reinforcement member; and
at least one string bearing member adapted to fit on a portion of an outward facing surface of the game racket frame and on top of an outside portion of the at least one reinforcement member and support the at least one game racket string, wherein the at least one string bearing member contacts the at least one game racket string.

16. A method for making a composite game racket frame, comprising the acts of:
preparing at least one bladder with at least one elongated opening for molding in a mold cavity;
wrapping exposed bladder surface areas with a pre-preg material to create a wrapped bladder;
placing the wrapped bladder in the mold cavity in a shape substantially similar to the game racket frame;
placing at least one spacer within the at least one elongated opening in the at least one bladder;
closing the mold cavity;
pressurizing the at least one bladder;
heating the mold cavity to fully cure the pre-preg material;
opening the mold cavity; and
removing the composite game racket frame from the mold cavity.

17. The method of claim 16, wherein the spacers comprise a hollow element.

18. The method of claim 16, further comprising the acts of:
removing the spacer from the game racket frame after removing the game racket frame from the mold cavity to create an elongated opening; and
inserting a reinforcement member in the elongated opening.

19. The method of claim 16, wherein the spacer is a reinforcement member.

20. The method of claim 16, further comprising locking in place intermediate mold members.

21. The method of claim 16, further comprising placing string bearing members on an outward facing portion of the reinforcement member.

22. The method of claim 16, wherein the at least one bladder is a double bladder.

23. The method of claim 16, further comprising the acts of:
placing a single bladder in the mold cavity;
placing and securing a hollow spacer in the mold cavity;
and placing a second bladder in the mold cavity.
